(19) United States
(12) Patent Application Publication
(10) Pub. No.: US 2016/0159196 A1
(43) Pub. Date: Jun. 9, 2016

(54) TEMPERATURE CONTROL APPARATUS AND CONTROL METHOD THEREOF

(71) Applicant: Hyundai Motor Company, Seoul (KR)

(72) Inventor: Dong Jun Shin, Suwon (KR)

(21) Appl. No.: 14/920,450

(22) Filed: Oct. 22, 2015

(30) Foreign Application Priority Data
Dec. 3, 2014 (KR) 10-2014-0172312

(51) Int. Cl. B60H 1/00

(52) U.S. Cl. CPC B60H 1/00392; B60H 1/00735; B60H 1/00428

(57) ABSTRACT

A temperature control apparatus includes an external temperature sensor that measure an external temperature of vehicle and an internal temperature sensor that measures an internal temperature of vehicle. Additionally, an input module receives a set temperature input and a controller sets a variance of target temperature based on at least one of the external temperature of vehicle, the internal temperature of vehicle, and the set temperature. The controller also calculates a variance of internal temperature of vehicle by a preset period using the internal temperature of vehicle and determines that a temperature control is completed when the variance of internal temperature is less than or equal to the variance of target temperature.

### CROSS-REFERENCE TO RELATED APPLICATION

This application claims the benefit of priority to Korean Patent Application No. 10-2014-0172312, filed on Dec. 3, 2014 in the Korean Intellectual Property Office, the disclosure of which is incorporated herein in its entirety by reference.

### BACKGROUND

1. Field of the Invention

The present invention relates to a temperature control apparatus mounted within a vehicle, and a method for controlling the same.

2. Description of the Related Art

Recently developed vehicles are equipped with a temperature control apparatus (e.g., an air controller). Generally, the temperature control apparatus compares a preset temperature set by a user with a measured temperature of vehicle interior to determine a time of temperature control completion. In particular, in a hybrid vehicle, since a voltage or a charging of battery is variably set based on the time of temperature control completion, it is important to accurately determine the time of temperature control completion of the vehicle.

However, due to the vehicle surroundings, the performance of the temperature control apparatus and the like, an error may occur while determining the time of temperature control completion, and accordingly, a battery voltage control or a fuel efficiency measurement may be affected.

### SUMMARY

The present invention provides a temperature control apparatus that reduces an error in determining a time of temperature control completion due to the vehicle surroundings, the performance of the temperature control apparatus and the like, while determining the time of temperature control completion of vehicle, and a method for controlling the same.

In accordance with an aspect of the present invention, a temperature control apparatus may include: an external temperature sensor configured to measure an external temperature of vehicle; an internal temperature sensor configured to measure an internal temperature of vehicle; an input module configured to receive a set temperature from a user; and a controller configured to set a variance of target temperature based on at least one of the external temperature of vehicle, the internal temperature of vehicle and the set temperature, calculate a variance of internal temperature of vehicle by a preset period using the internal temperature of vehicle, and determine that a temperature control is completed when the variance of internal temperature is less than or equal to the variance of target temperature.

The controller may further be configured to set the variance of target temperature when a difference between the external temperature of vehicle and the set temperature is substantial. In addition, the controller may be configured to set the variance of target temperature when a difference between the internal temperature of vehicle and the set temperature is substantial. The controller may further be configured to adjust the internal temperature sensor to measure the internal temperature of vehicle when a preset time is elapsed after a start-up of vehicle. The controller may be configured to change a calculation period of the variance of internal temperature of vehicle based on at least one of the external temperature of vehicle, the internal temperature of vehicle, and the set temperature.

In accordance with another aspect of the present invention, a method of controlling a temperature control apparatus may include: measuring an external temperature of vehicle; measuring an internal temperature of vehicle; receiving a set temperature input; setting a variance of target temperature based on at least one of the external temperature of vehicle, the internal temperature of vehicle, and the set temperature; calculating a variance of internal temperature of vehicle by a preset period using the internal temperature of vehicle; comparing the variance of internal temperature of vehicle with the variance of target temperature; and determining that a temperature control is completed when the variance of internal temperature is less than or equal to the variance of target temperature.

Further, the setting of a variance of target temperature may include setting the variance of target temperature when a difference between the external temperature of vehicle and the set temperature is substantial and setting a variance of target temperature when a difference between the internal temperature of vehicle and the set temperature is substantial. The measuring of an internal temperature of vehicle may include measuring the internal temperature of vehicle when a preset time is elapsed after a start-up of vehicle. In addition, the calculation of a variance of internal temperature of vehicle may include changing a calculation period of the variance of internal temperature of vehicle based on at least one of the external temperature of vehicle, the internal temperature of vehicle, and the set temperature.

### BRIEF DESCRIPTION OF THE DRAWINGS

The objects, features and advantages of the present invention will be more apparent from the following detailed description in conjunction with the accompanying drawings, in which:

FIG. 1 is a diagram illustrating a configuration of a temperature control apparatus according to various exemplary embodiments of the present invention; and

FIG. 2 is a flowchart illustrating a method for controlling a temperature control apparatus according to various exemplary embodiments of the present invention.

### DETAILED DESCRIPTION

Various embodiments of the present disclosure are described with reference to the accompanying drawings in detail. Although exemplary embodiments have been described with reference to a number of illustrative embodiments thereof, it should be understood that numerous other modifications and exemplary embodiments can be devised by those skilled in the art that will fall within the spirit and scope of the principles of the present invention. The same reference numbers are used throughout the drawings to refer to the same or like parts. Detailed descriptions of well-known functions and structures incorporated herein may be omitted to avoid obscuring the subject matter of the present invention.

The expressions such as “include” or “may include” which may be used in various embodiments denote the presence of the disclosed functions, operations, and constituent elements and do not limit one or more additional functions, operations, and constituent elements. In various embodiments of the present disclosure, the terms such as “include” or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof. Furthermore, in various embodiments, the expression “or” includes any and all combinations of the associated listed words. For example, the expression “A or B” may include A, may include B, or may include both A and B.

In various embodiments, expressions including ordinal numbers, such as “first”, “second” or the like may modify various elements. However, such elements are not limited by the above expressions. For example, the above expressions do not limit the sequence and/or importance of the elements. The above expressions are used merely for the purpose to distinguish an element from the other elements. For example, a first user device and a second user device indicate different user devices although both of the first user device and the second user device are user devices. For example, a first element could be termed a second element, and similarly, a second element could be also termed a first element without departing from the scope of various embodiments of the present disclosure.

The terms used in various exemplary embodiments are only used to describe specific various embodiments, and are not intended to limit various embodiments of the present disclosure. Singular forms are intended to include plural forms unless the context clearly indicates otherwise. Unless defined otherwise, the terms including technical and scientific terms used in this specification may have the meaning that can be commonly apprehended by those skilled in the art. The terms, such as the terms defined in the commonly-used dictionary, must be interpreted based on the context of the related technology and must not be interpreted ideally or excessively.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Although exemplary embodiment is described as using a plurality of units to perform the exemplary process, it is understood that the exemplary processes may also be performed by one or plurality of modules. Additionally, it is understood that the term controller/control unit/control module refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

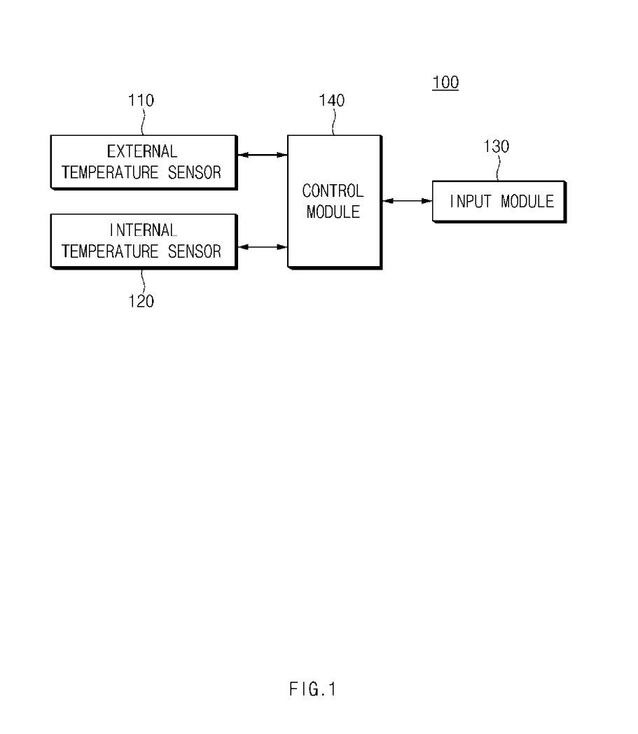

FIG. 1 is a diagram illustrating a configuration of a temperature control apparatus according to various exemplary embodiments of the present invention. The temperature control apparatus 100 according to various exemplary embodiments of the present invention may determine a completion time of heating/cooling using a variance in temperature of vehicle interior. Particularly, by using the variance in temperature to determine the completion time of heating/cooling of vehicle, the completion time of heating/cooling of vehicle may be determined more accurately.

Referring to FIG. 1, the temperature control apparatus 100 may include an external temperature sensor 110, an internal temperature sensor 120, an input module 130 and a controller 140. In particular, the external temperature sensor 110 may be configured to measure an external temperature of vehicle and transmit information regarding the measured external temperature of vehicle to the controller 140.

Further, the internal temperature sensor 120 may be configured to measure an internal temperature of vehicle and transmit information regarding the measured internal temperature of vehicle to the controller 140. According to an exemplary embodiment, the internal temperature sensor 120 may be configured to measure the internal temperature of vehicle when a preset time (e.g., about two minutes) elapses after start-up of vehicle to reduce an error.

According to an exemplary embodiment, the temperature control apparatus 100 may include a sensor hub (not shown) configured to adjust the external temperature sensor 110 and the internal temperature sensor 120. The sensor hub (not shown) may be configured to adjust the external temperature sensor 110 and the internal temperature sensor 120 to measure a temperature, and may be configured to receive and manage measured temperature information.

The input module 130 may be configured to receive a user operation (e.g., input, selection, or the like). According to an exemplary embodiment, the input module 130 may include a touch panel, a touch screen included in a display mounted within the vehicle, or various input buttons, a jog switch mounted within the vehicle or the like. Additionally, the input module 130 may be configured to receive a set temperature from the user (e.g., a temperature input).

The controller 140 may be configured to execute the overall operation of the temperature control apparatus 100. For example, the controller 140 may be configured to operate the external temperature sensor 110, the internal temperature sensor 120 and the input module 130 to determine whether the temperature control is completed according to various exemplary embodiments of the present invention.

Particularly, the controller 140 may be configured to set a variance of target temperature based on at least one of the external temperature of vehicle, the internal temperature of vehicle, and the set temperature. For example, the controller 140 may be configured to set the variance of target temperature based on the external temperature of vehicle and the set temperature, and may be configured to correct the variance of target temperature using the internal temperature of vehicle. The controller 140 may further be configured to set the variance of target temperature corresponding to the external temperature of vehicle, the internal temperature of vehicle, and the set temperature.

According to an exemplary embodiment, the controller 140 may be configured to set the variance of target temperature when the difference between the external temperature of vehicle and the set temperature is substantial. According to an exemplary embodiment, the controller 140 may be configured to set the variance of target temperature when the difference between the internal temperature of vehicle and the set temperature is substantial.

According to an exemplary embodiment, the controller 140 may be configured to set the variance of target temperature using a mapping table previously stored in the memory (not shown). The controller 140 may then be configured to compare the external temperature of vehicle, the internal temperature of vehicle, and the set temperature received from the external temperature sensor 110, the internal temperature sensor 120, and the input module 130 with the pre-stored mapping table to set a corresponding variance of target temperature. The memory (not shown) may be configured to store, for example, a mapping table in which the variance of target temperature that corresponds to the external temperature of vehicle and the set temperature is mapped and a mapping table in which a correction factor that corresponds to the external temperature of vehicle and the internal temperature of vehicle may be mapped. Additionally, the memory (not shown) may be configured to store a mapping table in which the variance of target temperature that corresponds to the external temperature of vehicle, the internal temperature of vehicle, and the set temperature may be mapped.

Furthermore, the controller 140 may be configured to calculate the variance of target temperature using a formula in which the external temperature of vehicle, the internal temperature of vehicle and the set temperature are set as variables. The controller 140 may additionally be configured to calculate the variance of internal temperature of vehicle by a preset period (e.g., about thirty seconds or one minute) using the internal temperature of vehicle measured by the internal temperature sensor 120. The controller 140 may then be configured to adjust a calculation period of the variance of internal temperature of vehicle based on at least one of the external temperature of vehicle, the internal temperature of vehicle, and the set temperature. For example, when the difference between the internal temperature of vehicle and the set temperature is substantial, the calculation period of the variance of internal temperature of vehicle may be set to be a longer period of time.

Additionally, the controller 140 may be configured to compare the variance of internal temperature with the variance of target temperature and determine whether the temperature control is completed based on the comparison result. For example, the controller 140 may be configured to determine that the temperature control is completed when the variance of internal temperature is less than or equal to the variance of target temperature, and may be configured to determine that the temperature control is not completed when the variance of internal temperature is greater than the variance of target temperature.

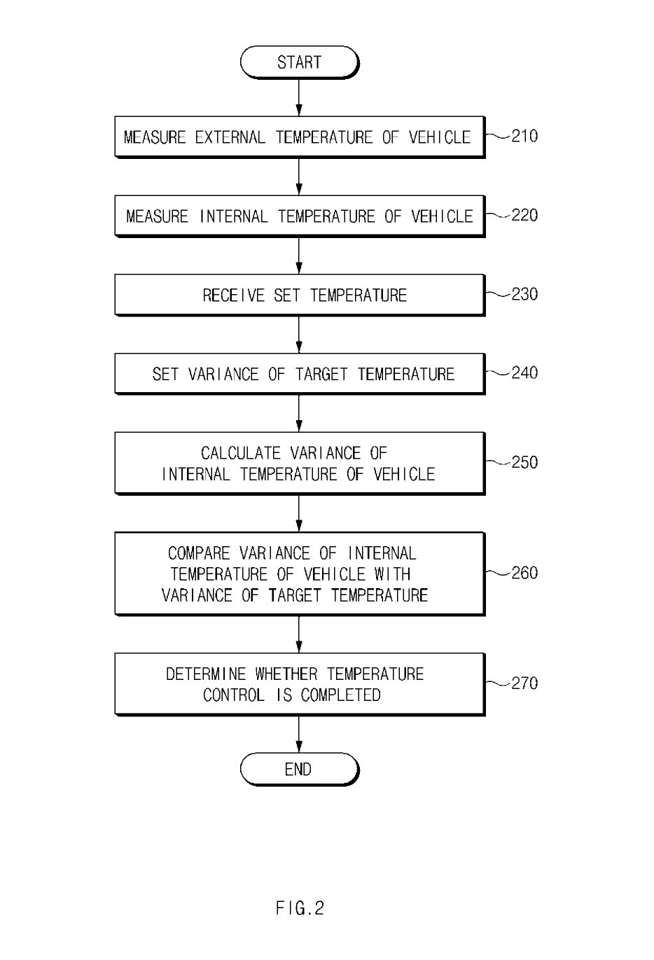

FIG. 2 is a flowchart illustrating a method for controlling a temperature control apparatus according to various exemplary embodiments of the present invention. The flowchart shown in FIG. 2 may be configured of operations processed in the temperature control apparatus 100 shown in FIG. 1. Hence, the content, even if it is omitted, which is described for the temperature control apparatus 100 with reference to FIG. 1 may also be applied to the flowchart shown in FIG. 2.

Referring to FIG. 2, the temperature control apparatus 100 may be configured to measure the external temperature of vehicle using the external temperature sensor (210) and may be configured to measure the internal temperature of vehicle using the internal temperature sensor (220). In the temperature control apparatus 100 according to an exemplary embodiment, the internal temperature sensor 120 may be configured to measure the internal temperature of vehicle when a preset time (e.g., about one minute) elapses after the start-up of vehicle to reduce an error. The temperature control apparatus 100 may be configured to receive a set temperature input (e.g., a user input) (230).

The above described operations 210 to 230 may be performed regardless of order of time. For example, the temperature control apparatus 100 may be configured to measure the external temperature of vehicle and the internal temperature of vehicle simultaneously, or measure the internal temperature of vehicle after receiving the set temperature input.

The temperature control apparatus 100 may be configured to set the variance of target temperature based on at least one of the external temperature of vehicle, the internal temperature of vehicle, and the set temperature (240). For example, the temperature control apparatus 100 may be configured to set the variance of target temperature based on the external temperature of vehicle and the set temperature, and correct the variance of target temperature using the internal temperature of vehicle. Additionally, the temperature control apparatus 100 may be configured to set the variance of target temperature that corresponds to the external temperature of vehicle, the internal temperature of vehicle, and the set temperature.

According to an exemplary embodiment, the temperature control apparatus 100 may be configured to set the variance of target temperature when the difference between the external temperature of vehicle and the set temperature is substantial. Further, the temperature control apparatus 100 may be configured to set the variance of target temperature when the difference between the internal temperature of vehicle and the set temperature is substantial. The temperature control apparatus 100 may be configured to set the variance of target temperature using a mapping table previously stored in the memory (not shown). In addition, the temperature control apparatus 100 may be configured to compare the external temperature of vehicle, the internal temperature of vehicle, and the set temperature received from the external temperature sensor 110, the internal temperature sensor 120, and the input module 130 with the pre-stored mapping table to set a corresponding variance of target temperature.

The memory (not shown) may be configured to store, for example, a mapping table in which the variance of target temperature that corresponds to the external temperature of vehicle and the set temperature may be mapped and a mapping table in which a correction factor that corresponds to the external temperature of vehicle and the internal temperature of vehicle may be mapped. Additionally, the memory (not shown) may be configured to store a mapping table in which the variance of target temperature corresponding to the external temperature of vehicle, the internal temperature of vehicle, and the set temperature is mapped.

According to an exemplary embodiment, the temperature control apparatus 100 may be configured to calculate the variance of target temperature using a formula in which the external temperature of vehicle, the internal temperature of vehicle and the set temperature are set as variables. The temperature control apparatus 100 may further be configured to calculate the variance of internal temperature of vehicle by a preset period (e.g., about thirty seconds or one minute) using the internal temperature of vehicle measured by the internal temperature sensor 120 (250). Additionally, the temperature control apparatus 100 may be configured to change or adjust a calculation period of the variance of internal temperature of vehicle based on at least one of the external temperature of vehicle, the internal temperature of vehicle, and the set temperature. For example, when the difference between the internal temperature of vehicle and the set temperature is substantial, the calculation period of the variance of internal temperature of vehicle may be increased (e.g., set to be a longer period of time).

Furthermore, the temperature control apparatus 100 may be configured to compare the variance of internal temperature with the variance of target temperature (260). The temperature control apparatus 100 may be configured to determine whether the temperature control is completed based on the comparison result (270). For example, the temperature control apparatus 100 may be configured to determine that the temperature control is completed when the variance of internal temperature is less than or equal to the variance of target temperature, and determine that the temperature control is not completed when the variance of internal temperature is greater than the variance of target temperature.

According to various exemplary embodiments of the present invention, the error, which may occur while determining the time of temperature control completion due to the vehicle surroundings, the performance of the temperature control apparatus and the like, may be reduced, and accordingly, the error in the battery voltage control or the fuel efficiency measurement may also be reduced.

The term “module” used in the present disclosure may refer to, for example, a “unit” including one of hardware, software, and firmware, or a combination of two or more thereof. The term “module” may be interchangeable with a term such as a unit, a logic, a logical block, a component, or a circuit. The “module” may be a minimum unit of an integrated component or a part thereof. The “module” may be a minimum unit for performing one or more functions or a part thereof. The “module” may be mechanically or electronically implemented. For example, the “module” may include at least one of an Application-Specific Integrated Circuit (ASIC) chip, a Field-Programmable Gate Arrays (FPGA), and a programmable-logic device for performing operations which has been known or are to be developed hereinafter.

According to various exemplary embodiments of the present disclosure, at least some of the devices (e.g., modules or functions thereof) or the method (e.g., operations) may be implemented by a command stored in a computer-readable storage media in a programming module form. When the command is executed by a processor (e.g., the controller 130 or 230), the one or more processors may execute a function corresponding to the command. The computer-readable storage media may be, for example, the memory (110 or 210).

A module or a program module according to various exemplary embodiments may include at least one of the aforementioned elements, omit some elements, or further include additional different elements. Operations performed by the module, the program module or other elements according to various exemplary embodiments may be executed sequentially, in parallel, iteratively or heuristically. In addition, some operations may be executed in a different order or may be omitted, or other operation may be added

Although exemplary embodiments of the present invention have been described in detail hereinabove, it should be clearly understood that many variations and modifications of the basic inventive concepts herein taught which may appear to those skilled in the present art will still fall within the spirit and scope of the present invention, as defined in the appended claims.

What is claimed is:

1. A temperature control apparatus, comprising:
an external temperature sensor configured to measure an external temperature of vehicle;
an internal temperature sensor configured to measure an internal temperature of vehicle;
an input module configured to receive a set temperature input; and
a controller configured to set a variance of target temperature based on at least one of the external temperature of vehicle, the internal temperature of vehicle, and the set temperature, calculate a variance of internal temperature of vehicle by a preset period using the internal temperature of vehicle, and determine that a temperature control is completed when the variance of internal temperature is less than or equal to the variance of target temperature.

2. The temperature control apparatus of claim 1, wherein the controller is configured to set the variance of target temperature when a difference between the external temperature of vehicle and the set temperature is substantial.

3. The temperature control apparatus of claim 1, wherein the controller is configured to set the variance of target temperature when a difference between the internal temperature of vehicle and the set temperature is substantial.

4. The temperature control apparatus of claim 1, wherein the controller is configured to operate the internal temperature sensor to measure the internal temperature of vehicle when a preset time elapses after a start-up of vehicle.

5. The temperature control apparatus of claim 1, wherein the controller is configured to adjust a calculation period of the variance of internal temperature of vehicle based on at least one selected from the group consisting of: the external temperature of vehicle, the internal temperature of vehicle, and the set temperature.

6. A method of controlling a temperature control apparatus, comprising:
measuring, by an external temperature sensor, an external temperature of vehicle;
measuring, by an internal temperature sensor, an internal temperature of vehicle;
receiving, by a controller, a set temperature input;
setting, by the controller, a variance of target temperature based on at least one of the external temperature of vehicle, the internal temperature of vehicle and the set temperature;
calculating, by the controller, a variance of internal temperature of vehicle by a preset period using the internal temperature of vehicle;
comparing, by the controller, the variance of internal temperature of vehicle with the variance of target temperature; and
determining, by the controller, that a temperature control is completed when the variance of internal temperature is less than or equal to the variance of target temperature.

7. The method of claim 6, wherein setting a variance of target temperature includes setting, by the controller, the variance of target temperature when a difference between the external temperature of vehicle and the set temperature is substantial.

8. The method of claim 6, wherein setting a variance of target temperature includes setting, by the controller, the variance of target temperature significantly when a difference between the internal temperature of vehicle and the set temperature is substantial.

9. The method of claim 6, wherein measuring an internal temperature of vehicle includes measuring, by the internal temperature sensor, the internal temperature of vehicle when a preset time elapses after a start-up of vehicle.

10. The method of claim 6, wherein calculating a variance of internal temperature of vehicle includes adjusting, by the controller, a calculation period of the variance of internal temperature of vehicle based on at least one selected from the group consisting of: the external temperature of vehicle, the internal temperature of vehicle, and the set temperature.

11. A non-transitory computer readable medium containing program instructions executed by a controller, the computer readable medium comprising:
program instructions that control an external temperature sensor to measure an external temperature of vehicle;
program instructions that control an internal temperature sensor to measure an internal temperature of vehicle;
program instructions that receive a set temperature input;
program instructions that set a variance of target temperature based on at least one of the external temperature of vehicle, the internal temperature of vehicle and the set temperature;
program instructions that calculate a variance of internal temperature of vehicle by a preset period using the internal temperature of vehicle;
program instructions that compare the variance of internal temperature of vehicle with the variance of target temperature; and
program instructions that determine that a temperature control is completed when the variance of internal temperature is less than or equal to the variance of target temperature.

12. The non-transitory computer readable medium of claim 11, wherein the program instructions that set a variance of target temperature program instructions that set the variance of target temperature when a difference between the external temperature of vehicle and the set temperature is substantial.

13. The non-transitory computer readable medium of claim 11, wherein the program instructions that set a variance of target temperature program instructions that set the variance of target temperature significantly when a difference between the internal temperature of vehicle and the set temperature is substantial.

14. The non-transitory computer readable medium of claim 11, wherein the program instructions that measure an internal temperature of vehicle program instructions that control the internal temperature sensor to measure the internal temperature of vehicle when a preset time elapses after a start-up of vehicle.

15. The non-transitory computer readable medium of claim 11, wherein the program instructions that calculate a variance of internal temperature of vehicle include program instructions that adjust a calculation period of the variance of internal temperature of vehicle based on at least one selected from the group consisting of: the external temperature of vehicle, the internal temperature of vehicle, and the set temperature.
